(19) United States
(12) Patent Application Publication
(10) Pub. No.: US 2025/0068489 A1
(43) Pub. Date: Feb. 27, 2025

(54) DATA PROCESSING METHOD, TERMINAL DEVICE, AND STORAGE MEDIUM

(71) Applicant: PAX COMPUTER TECHNOLOGY (SHENZHEN) CO., LTD., Shenzhen (CN)

(72) Inventor: CHUNLEI ZHAO, Shenzhen (CN)

(21) Appl. No.: 18/724,627

(22) PCT Filed: Aug. 30, 2022
(86) PCT No.: PCT/CN2022/115885

§ 371 Date: Jun. 27, 2024

(30) Foreign Application Priority Data
Dec. 30, 2021 (CN) 20211652836.6

(51) Int. Cl. G06F 9/54; G06F 8/41; G06F 9/30; G06F 9/451

(52) U.S. Cl. CPC G06F 9/54; G06F 8/41; G06F 9/3017; G06F 9/451

(57) ABSTRACT

The present application is applicable to a field of computer technology, and provides a data processing method, a terminal device, and a storage medium. The data processing method comprises: invoking a library interface of a middle layer library by using an upper layer application; implementing a function corresponding to the library interface by invoking a bottom layer application programming interface by the middle layer library. The data processing method provided in the embodiment of the present application can reduce the difficulty of developing upper layer applications.

This application claims priority to Chinese Patent Application No. 202111652836. 6 filed on Dec. 30, 2021, in China National Intellectual Property Administration, the contents of which are incorporated by reference herein.

### FIELD

The subject matter herein generally relates to a field of computer technology, and more particularly to a data processing method, a terminal device, and a storage medium.

### BACKGROUND

In some cases, an application software of point of sale (POS) terminal needs to be rewritten. In the current application development platform of the POS terminal, an upper layer application directly calls a bottom layer application programming interface (API) of the POS terminal in various models, and then writes data to the POS terminal.

Since there are many demanders for applications of the POS terminal, and the demanders must comply with industry standards, once the industry standards change, different demanders will propose a same modification requirement. In the current application development platform, codes of each application need to be compared with the standard version code, and then a modification is transplanted to a personalized application of the demanders, which makes the development of the upper layer application very difficult.

### SUMMARY

### Technical Problem

The embodiments of the present application provide a data processing method, a terminal device and a storage medium, which can reduce the difficulty of developing upper-layer applications.

### Technical Solutions

In a first aspect, an embodiment of the present application provides a data processing method, including:
invoking a library interface of a middle layer library by using an upper layer application;
implementing a function corresponding to the library interface by invoking a bottom layer application programming interface by the middle layer library.

In a possible implementation of the first aspect, the method further includes:
obtaining designated function data;
encapsulating the designated function data into function modules and generating the library interface.

In a possible implementation of the first aspect, obtaining the designated function data includes:
obtaining function data;
classifying the function data and obtaining the designated function data.

In a possible implementation of the first aspect, encapsulating the designated function data into the function modules and generating the library interface includes:
defining difference of a plurality of designated function data by macros;
generating corresponding library interface for the plurality of designated function data defined by the macros.

In a possible implementation of the first aspect, generating corresponding library interface includes:
compiling and generating the corresponding library interface respectively by using a script tool.

In a possible implementation of the first aspect, after generating the library interface, the method further includes:
adapting and debugging the library interface, and making the library interface adapt to the device.

In a possible implementation of the first aspect, encapsulating the designated function data into the function modules and generating the library interface includes:
setting parameter adjustment items for the designated function data, and encapsulating the function modules and generating the library interface.

In a possible implementation of the first aspect, invoking the library interface of the middle layer library by the upper layer application, includes:
sequentially invoking a plurality of library interfaces of the middle layer library by the upper layer application; or
directly invoking the library interface of the middle layer library by the upper layer application.

In a second aspect, an embodiment of the present application provides a terminal device, the device includes a memory, a processor and a computer program stored in the memory and executable on the processor, wherein the processor implements the above data processing method when executing the computer program.

In a third aspect, an embodiment of the present application provides a computer-readable storage medium, wherein the computer-readable storage medium stores a computer program, wherein the computer program implements the above data processing method when executed by the processor.

In a fourth aspect, an embodiment of the present application provides a computer program product, when the computer program product is run on a terminal device, the terminal device executes the data processing method described in any one of the above first aspects.

### Beneficial Effects

The beneficial effects of the embodiments of the present application compared with the prior art are as follows.

In an embodiment of the present application, the upper layer application invokes the library interface of the middle layer library, and the middle layer library calls the bottom layer application programming interface to implement the target function corresponding to the library interface; in this way, by using the middle layer library between the upper layer application and the bottom layer application programming interface, the differences between various devices can be compatible, which can reduce the difficulty of developing the upper layer application.

Some possible implementations of the embodiments of the present application have the following beneficial effects:

By defining the differences of multiple designated function data by macros, corresponding target library interfaces are generated in the middle layer library for the multiple designated function data defined by the macros; in this way, different models of target devices can be distinguished by macros, and the different function points of the upper layer application can be transferred to the middle layer library. The upper layer application only exposes one interface, which can reduce repeated development and testing work, thereby shortening the development cycle of the upper layer application.

### BRIEF DESCRIPTION OF THE DRAWINGS

In order to explain technical solutions of the embodiments of the present application more clearly, the drawings needed to be used in the description of the embodiments of the present application will be briefly introduced below. Obviously, the drawings in the following description are only some embodiments of the present application, for those of ordinary skill in the art, other drawings can also be obtained based on these drawings without exerting creative labor.

FIG. 1 is a schematic diagram of a system architecture of a terminal device provided in an embodiment of the present application.

FIG. 2 is a schematic flow chart of a data processing method provided in an embodiment of the present application.

FIG. 3 is a schematic diagram of a software architecture applied in the data processing method provided in an embodiment of the present application.

FIG. 4 is a schematic flow chart of a data processing method provided in another embodiment of the present application.

FIG. 5 is a schematic flow chart of a step B1 of the data processing method provided in the embodiment of the present application.

FIG. 6 is a schematic flow chart of a step B2 of the data processing method provided in the embodiment of the present application.

FIG. 7 is a schematic flow chart of the data processing method provided in another embodiment of the present application.

FIG. 8 is a structure schematic diagram of a terminal device provided in an embodiment of the present application.

### DETAILED DESCRIPTION

### Embodiments of the Present Application

In order to make technical problems to be solved in the present application, technical solutions and beneficial effects clearer, the present application is further described in detail below in conjunction with accompanying FIGS. 1 to 8 and embodiments. It should be understood that the specific embodiments described herein are only used to explain the present application and are not intended to limit the present application.

In the following description, in order to illustrate rather than to limit, specific details such as specific system structure, technology are proposed, so as to thoroughly understand the embodiments of the present application. However, it should be clear to those skilled in the art that in other embodiments without these specific details, the present application can also be realized. In other cases, a detailed description of a well-known system, device, circuit and method is omitted to avoid unnecessary details hindering the description of the present application.

It should be understood that the term “comprising” used in the present specification and the appended claims indicates the presence of described features, wholes, steps, operations, elements and/or components, but does not exclude the presence or addition of one or more other features, wholes, steps, operations, elements, components and/or collections thereof.

It should also be understood that the term “and/or” used in the specification and appended claims of the application refers to any combination and all possible combinations of one or more of the associated listed items, and includes these combinations.

As used in the present specification and the appended claims, the term “if” can be interpreted as “when” or “once” or “in response to determining” or “in response to detecting” according to the context. Similarly, the phrase “if it is determined” or “if [described condition or event] is detected” can be interpreted as meaning “once it is determined” or “in response to determining” or “once [described condition or event] is detected” or “in response to detecting [described condition or event]” according to the context.

In addition, in the description of the present specification and the appended claims of the application, the terms “first”, “second”, “third”, etc., are only used to distinguish the descriptions and cannot be understood as indicating or implying relative importance.

Reference “one embodiment” or “some embodiments”, etc., described in the present application specification sheet means to include in one or more embodiments of the present application the specific features, structure or characteristics described in conjunction with the embodiment. Therefore, the statements “in one embodiment”, “in some embodiments”, “in some other embodiments”, “in some other embodiments”, etc., that appear in the difference in the specification sheet are not necessarily all with reference to the same embodiment, but mean “one or more but not all embodiments”, unless otherwise particularly emphasized. Term “comprises”, “includes”, “has” and their deformation all mean “including but not limited to”, unless otherwise particularly emphasized.

The embodiments of the present application provide a data processing method, and the method can be applied to an application operation or application development of a terminal device.

The aforementioned terminal device may be a POS terminal, a mobile phone, a tablet computer, a wearable device, a vehicle-mounted device, an augmented reality (AR)/virtual reality (VR) device, a notebook computer, an ultra-mobile personal computer (UMPC), a netbook, a personal digital assistant (PDA), and the like. The embodiments of the present application do not impose any restrictions on the specific type of the terminal device.

FIG. 1 is a schematic diagram of a system architecture of a terminal device provided in an embodiment of the present application. Referring to FIG. 1, the terminal device provided by the embodiment of the present application includes an upper layer application 100 and a middle layer library 200.

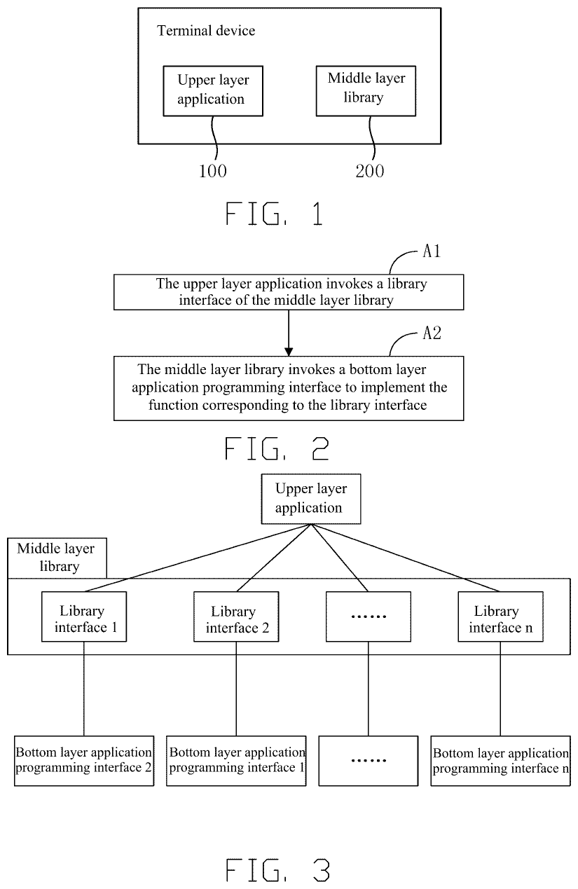

FIG. 2 is a schematic flow chart of a data processing method provided in an embodiment of the present application. Referring to FIG. 2, the data processing method provided by an embodiment of the present application includes step A1 and step A2.

Step A1: the upper layer application invokes a library interface of the middle layer library.

The middle layer library 200 is a group of static libraries corresponding to different terminal devices, which exist in the form of library interfaces (such as library files). The static library can be a .a library.

The library interface has one or more interface functions. One library interface is a function module.

In some embodiments, the middle layer library 200 includes library interfaces such as a communication function module, a debugging function module, a display function module, an Europay MasterCard Visa (EMV) function module, an ISO8583 function module, a parameter setting function module, a password keyboard function module, a printing function module, a public basic function module, a system function module, and a remote update function module.

The communication function module supports various communication modes such as wireless network communication (Wi-Fi), General Packet Radio Service (GPRS), Code Division Multiple Access (CDMA), 4G, Ethernet, serial port, and dial-up, and can automatically connect to a device for communication based on whether the device supports the above communication mode.

In the communication function module, the previous application code encapsulates the interfaces of functions such as socket connection, sending, and receiving for different communication modes. In fact, the socket communication of different modules can be universal, so a Comm_Init interface is added before the socket communication. A corresponding parameters under different communication modes are passed in by input parameters of a structure to realize a preparation work before communication. For example, the communication function module of the GPRS must first perform base station connection, and the communication function module of WiFi must first perform hotspot connection.

The debug function module outputs debug logs by serial port or Universal Serial Bus (USB) port or display, printing and other means. The debug function module are equipped with multiple (e.g. 5) levels of log output capability, and an interface for setting log output mode manually or by function call.

The prior applications did not have a fixed interface for debugging. All applications are temporarily wrote a simple debugging interface when needed, the desired debugging information is displayed by a serial port or a screen, and then the debugging code is deleted before publishing or the debugging code is closed by using a macro. The embodiment of the present application adds one debugging function module to the middle layer library, and can set a mode and a level of debugging output by invoking a debug_setDebugInfo function. It is also possible to manually open the log, select the log information output method and the log level in the released version of the program by invoking the Debug_setDebugPort function in a parameter setting menu, which is convenient for troubleshooting the cause of the problems in production.

The display function module provides functions such as clearing the screen, clearing a single line, displaying a specified line, displaying a specified position, displaying a specified pixel position, displaying a QR code or barcode, large and small fonts, color fonts and cash back.

The EMV function module provides PBOC and QPBOC functions, and supports plug-in card and contactless card functions.

The ISO8583 function module provides an iso8583 packaging function.

The parameter setting function module provides functions such as setting Boolean values, numbers, Chinese and English strings, etc.; and configures parameters by configuring parameter type structure array.

In the parameter setting function module, all parameters of the prior upper layer application are in string format, which need to be converted into the required format when used, and then converted back to the string format when set. The embodiment of the present application adds formats such as Boolean values, numbers, Chinese and English strings in the middle layer library, which can be conveniently stored and read in a desired format, and can simplify the code logic.

The password keyboard function module provides functions such as Personal Identification Number (PIN) input, working key, master key, US Data Encryption Standard (DES) key download, encryption and decryption and other functions.

The printing function module provides functions such as picture printing, QR code printing, string printing, and printer paper feeding.

The public basic function module provides basic functions such as electronic signature, various transcoding functions, file operations, etc.

The system function module provides functions such as system initialization, obtaining terminal model, screen size, date and time, battery power, printer mode, sleep, Serial Number (SN), etc.

The remote update function module provides functions such as application remote update and parameter remote download.

The library interface invoked by the upper layer application 100 to implement a target business logic is a target library interface. Specifically, the upper layer application 100 implements the target business logic of the upper layer application 100 by invoking the interface function provided by the target library interface of the middle layer library 200.

The upper layer application can directly invoke one target library interface of the middle layer library. For an independent function, the upper layer application can directly invoke the target library interface corresponding to the independent function.

The upper layer application may also sequentially invoke a number of target library interfaces of the middle layer library. For non-independent functions, the upper layer application needs to sequentially invoke the number of target library interfaces of the middle layer library, for example, for the communication printing function, the upper layer application first invokes the target library interface corresponding to the communication function, and then invokes the target library interface corresponding to the printing function, thereby realizing the communication printing function.

Step A2: the middle layer library invokes a bottom layer application programming interface to implement the function corresponding to the library interface.

The terminal device has the bottom layer application programming interface.

FIG. 3 is a schematic diagram of a software architecture applied in the data processing method provided in an embodiment of the present application. Referring to FIG. 3, an intermediate layer library 200 between the upper layer application 100 and various bottom layer application programming interfaces is existed. All functions of the upper layer application 100 are implemented by invoking the interface provided by the intermediate layer library 200.

The middle layer library 200 implements the interface function provided by the target library interface of the middle layer library 200 by invoking the target bottom layer application programming interface of the terminal device, thereby realizing the target function corresponding to the target library interface, such as realizing the Wi-Fi communication function. In the embodiment, differences in the bottom layer application programming interfaces of various models are compatible and shielded by the middle layer library. The upper layer application invokes the middle layer library and compiles based on the library interface output by various terminal devices to generate program files suitable for various terminal devices.

According to the above content, it can be known that the upper layer application invokes the library interface of the middle layer library, and the middle layer library invokes the bottom layer application programming interface to implement the functions corresponding to the library interface, in this way, by the middle layer library between the upper layer application and the bottom layer application programming interface, it is compatible with the differences between various devices, which can reduce the difficulty of developing the upper layer application, and can achieve the compilation of applications suitable for various devices with a set of application codes.

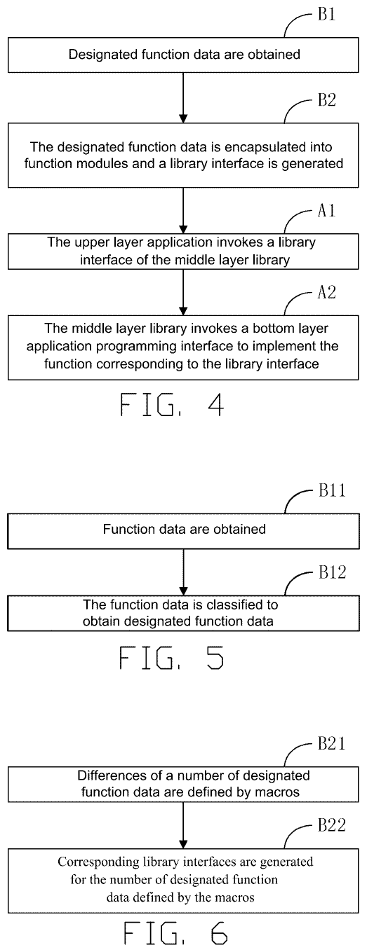

FIG. 4 is a schematic flow chart of a data processing method provided in another embodiment of the present application. Referring to FIG. 4, in some embodiments, before step A1 and step A2, the data processing method further includes step B1 and step B2.

Step B1, designated function data are obtained.

FIG. 5 is a schematic flow chart of a step B1 of the data processing method provided in the embodiment of the present application. Referring to FIG. 5, in some embodiments, step B1 (obtaining designated function data) includes step B11 and step B12.

Step B11, function data are obtained.

The function data is data representing the basic functions of a device. The basic functions of a device may be Wi-Fi communication, PIN input, or QR code printing.

The basic functions of different models of devices may be different, and these basic functions represent the needs of different demand parties. For example, device A uses Wi-Fi communication mode, and device B uses Ethernet communication mode, then, the corresponding function data of the Wi-Fi communication mode and the Ethernet communication mode is also different.

Step B12: the function data is classified to obtain designated function data.

The obtained function data may belong to a same category, for example, Wi-Fi communication mode and Ethernet communication mode belong to communication functions, therefore, all function data may be classified to obtain designated function data.

The designated function data represents a class of functions, including one or more function data.

For example, the designated function data can be communication function data, debugging function data, display function data, EMV function data, ISO8583 function data, parameter setting function data, password keyboard function data, printing function data, public basic function data, system function data, and remote update function data, etc.

Step B2: the designated function data is encapsulated into function modules and a library interface is generated.

After obtaining the designated function data, all the designated function data are encapsulated into function modules and compiled into a library file, thereby obtaining the library interface, such as a library interface of a communication function module, a debugging function module, a display function module, an EMV function module, an ISO8583 function module, a parameter setting function module, a password keyboard function module, a printing function module, a public basic function module, a system function module, and a remote update function module.

It should be understood that the library interface (such as the library file) is generated based on the function data of various types of equipment (such as POS terminals) and can be applicable to various types of equipment.

According to the above content, the demands from different demand parties are integrated, and then similar items are merged, and the same or similar demands are transferred to the middle layer library for implementation, thereby completing the integration and accumulation of personalized demands of upper layer applications.

Based on the integration and accumulation of the above-mentioned needs and a unified middle layer library service interface, once a new product appears, it is only necessary to debug the interface functions of the new product in the middle layer library to support the upper layer applications that have been released on the market. There is no need to use each released upper layer application to repeatedly adapt the new product, which can greatly reduce the development period of various upper layer applications and speed up the introduction of new products.

In some embodiments, step B2 (encapsulating the designated function data into the function modules and generating the library interface) specifically includes: setting parameter adjustment items for the designated function data and encapsulating the function modules and generating a library interface.

Specifically, all functional requirements are integrated and analyzed, and the same or similar functions are implemented in each function module involved, and then different parameters are used for personalized differentiation.

For example, function S is to obtain the information of the current keyboard input in the form of a string. The function is a basic function that each upper layer application must use; the letter input, by default, is to switch between uppercase and lowercase letters by the [Function] key, but some requirements are to switch by pressing the same key multiple times, and the key interval time is slightly different. For this reason, an adjustment item of a switching mode and an adjustment item of an interval time are set for the designated function data corresponding to function S, and the function module is encapsulated to generate the corresponding library interface, so that the upper layer application can set different switching modes and interval times according to its own needs, therefore realizing personalized differentiation by using different parameters.

FIG. 6 is a schematic flow chart of a step B2 of the data processing method provided in the embodiment of the present application. Referring to FIG. 6, in some embodiments, step B2 (encapsulating the designated function data into the function modules and generating the library interface) includes step B21 and step B22.

Step B21, differences of a number of designated function data are defined by macros.

For devices of different models on each hardware platform, the differences in the designated function data corresponding to the different devices are distinguished using the macros, specifically, the differences in the number of designated function data are defined by the macros.

The use of macro control can shield the differences between different models, so that the upper layer application can be applied to more devices by the middle layer library.

Step B22: corresponding library interfaces are generated for the number of designated function data defined by the macros.

Specifically, after defining the number of designated function data by the macros, the corresponding library interfaces can be compiled and generated respectively by a script tool.

In this way, different types of terminal devices are distinguished by the macros, and the differences of the upper layer application are decentralized to the middle layer library. The upper layer application only exposes one interface, which can reduce repeated development and testing work, thereby shortening the upper layer application development cycle.

In actual use, different types of terminal devices need to invoke different interface functions to implement the same function, and the middle layer library uses the macros to define the differences between different types of terminal devices.

Taking different types of terminal devices to implement function L as an example, function L is: drawing a line on a screen of the terminal device.

Input parameters: a starting pixel position (BeginX, BeginY), an ending pixel position (EndX, EndY) and indication positive return display flag (Color). Corresponding code is: int Disp_DrawLine (intBeginX, int BeginY, int EndX, int EndY, char Color).

For the A series of terminal devices, since there are models that do not support color screens, the upper layer application invokes the interface function ScrPlot; for other models that only have color screens, the interface function CLcdDrawPixel is applicable.

The interface function ScrPlot requires that 0 represents a white line and 1 represents a black line for a positive return display; the interface function CLcdDrawPixel is on the contrary, 0 represents a black line, and 0xffffff represents a white line. In addition, terminal device itself does not support drawing oblique lines, and needs to be controlled in interface function.

The following is an implementation prototype of the interface function of the middle layer library.

```
  int Disp_DrawLine(int BeginX, int BeginY, int EndX, int EndY, char Color)
  {
  //intiRet;
  inttmp,i;
  int plotcolor;
  TERMINALINFOstInfo;
  memset ((char *)&stInfo, 0, sizeof (TERMINALINFO));
  Sys_GetTerminalInfo(&stInfo); //Get device information
  if (BeginX != EndX && BeginY != EndY) {
  returnDISP_FAIL; //does not support drawing diagonal lines
  }
  if (Color == 0) { //Color black dots
  #ifdef SXX
  plotcolor = 1; //System API non-zero plot point
  #else
  plotcolor = COLOR_BLACK;
  #endif
  }else{
  #ifdef SXX
  plotcolor = 0; //0 wipe point
  #else
  plotcolor = COLOR_WHITE;
  #endif
  }
  if (BeginX == EndX) { //x-axis coordinates are the same, indicating drawing a
vertical line
  if (BeginY>EndY) { // The starting position is greater than the ending position, so
the coordinates are reversed
  tmp = Begin Y;
  BeginY = EndY;
  EndY = tmp;
  }
  for(i= BeginY; i &lt; EndY; i++){ //Start drawing a vertical line
  #ifndef SXX
  CLcdDrawPixel(BeginX,i,plotcolor);
  #else
  ScrPlot (BeginX, i, plotcolor);
  #endif
  }
  }
  if (BeginY == EndY) { //y-axis coordinates are consistent, expressed as horizontal
lines
  if (BeginX>EndY) { //The starting position is greater than the ending position, so
the coordinates are reversed
  tmp = BeginX;
  BeginX=BeginY;
  Begin Y = tmp;
  }
  for(i=BeginX; i&lt;EndX; i++){//start drawing horizontal line
  #ifndef SXX
  CLcdDrawPixel(i,BeginY,plotcolor);
  #else
  ScrPlot (i, BeginY, plotcolor);
  #endif
  }
  }
  return DISP_SUCCESS;
  }
```

It can be seen that the use of macro control can effectively shield the differences between the models.

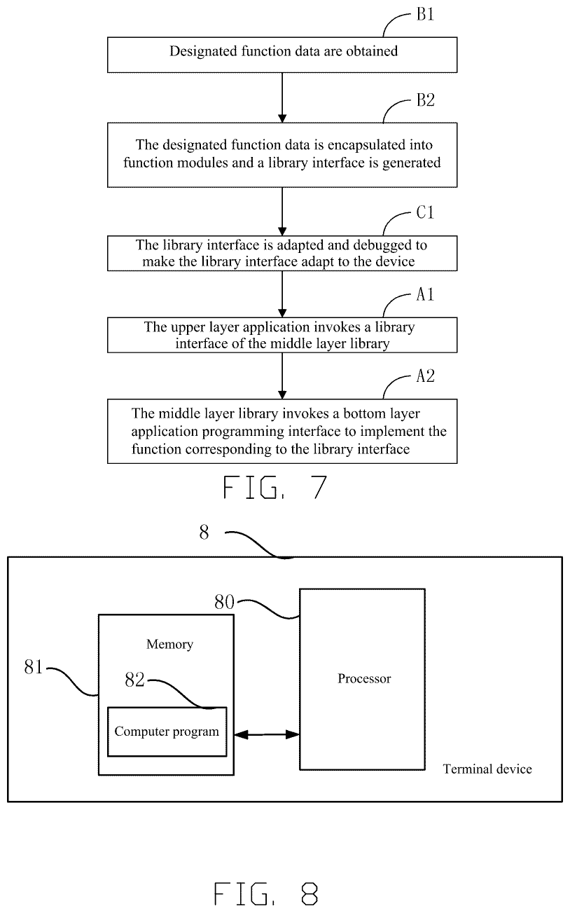

FIG. 7 is a schematic flow chart of the data processing method provided in another embodiment of the present application. Referring to FIG. 7, in some embodiments, step C1 is performed after generating the library interface.

Step C1, the library interface is adapted and debugged to make the library interface adapt to the device.

Specifically, after generating the library interface (ie, the function module), each function module is adapted and debugged for each device to ensure that the interface function of each function module is normal so that the function module can adapt to the target terminal device.

In the current application development platform of the POS terminals, the upper layer application directly invokes the bottom layer Application Programming Interface (API) of the POS terminal of various models, which not only needs to handle the personalized needs of the demand side, but also needs to perform various differentiated processing for different models, resulting in a large number of macro definitions and conditional judgments in the code, further resulting in poor code readability, which in turn makes transplantation very difficult. In addition, since there are many application demand sides, and the demand sides all need to comply with industry specifications, once the industry specifications change, different demand sides are very likely to propose the same modification requirements, and each application code needs to be compared with the standard version code, and then a modification is transplanted to the personalized application of the demand side according to a comparing result, which results in a huge amount of development and repeated work tasks, and wastes a lot of development power.

The data processing method provided by the embodiments of the present application can effectively solve the above-mentioned technical problems: the upper layer application implements its business logic by invoking the interface provided by the middle layer library, and the middle layer library implements the interface function by invoking the underlying API of each model; at the same time, for different models, the middle layer library can be compatible with their functional differences, so that the upper layer application is more versatile, and can reduce the situation where the upper layer application introduces a large number of macro definitions and conditional judgments for compatible models; some functions and requirements common to the upper layer application are delegated to the middle layer library for implementation, and for the same requirements of different demand parties, it is only necessary to adjust its functions in the middle layer library, which can greatly reduce the total development workload and avoid a lot of repetitive work when adapting to new models and different projects but with the same requirements during the application development process; once the same requirement changes (such as changes in industry specifications), only one developer needs to make corresponding adjustments in the middle layer library code for this requirement, and then distribute the modified library interface to other developers responsible for specific projects to complete the development of most of such required functions.

In summary, the data processing method provided by the embodiments of the present application can unify the development work of repeated requirements of the upper layer applications, greatly reducing the workload of development and debugging; and unify the work of adapting new products, and reduce the workload of development and debugging; and reduce the redundancy of upper layer application codes, and c increase code readability and portability.

FIG. 8 is a structure schematic diagram of a terminal device provided in an embodiment of the present application. As shown in FIG. 8, in the embodiment, the terminal device 8 includes at least one processor 80 (only one is shown in FIG. 8), a memory 81, and a computer program 82 stored in the memory 81 and executable on at least one processor 80. When the processor 80 executes the computer program 82, the steps in any of the above method embodiments are implemented.

The terminal device 8 may be a computing device such as a POS terminal, a desktop computer, a notebook, a palm computer, and a cloud server. The terminal device may include, but is not limited to, a processor 80 and a memory 81. Those skilled in the art will appreciate that FIG. 8 is merely an example of the terminal device and does not constitute a limitation on the terminal device, and may include more or fewer components than shown in the figure, or a combination of certain components, or different components, for example, may also include input and output devices, network access devices, buses, etc.

The processor 80 may be a central processing unit (CPU), or other general-purpose processors, digital signal processors (DSP), application-specific integrated circuits (ASIC), field-programmable gate arrays (FPGA), or other programmable logic devices, discrete gates or transistor logic devices, discrete hardware components, etc. A general-purpose processor may be a microprocessor or the processor may be any conventional processor, etc.

In some embodiments, the memory 81 may be an internal storage unit of the terminal device 8, such as a hard disk or memory of the terminal device. The memory 81 may also be an external storage device of the terminal device in other embodiments, such as a plug-in hard disk, a smart memory card (SMC), a secure digital (SD) card, a flash card, etc., equipped on the terminal device. Further, the memory 81 may also include both an internal storage unit of the terminal device and an external storage device. The memory 81 is used to store an operating system, an application program, a boot loader, data, and other programs, such as program codes of a computer program, etc. The memory 81 may also be used to temporarily store data that has been output or is to be output.

Exemplarily, the computer program 82 may be divided into one or more modules/units, one or more modules/units are stored in the memory 81, and are executed by the processor 80 to complete the present application. One or more modules/units may be a series of computer program instruction segments capable of completing specific functions, and the instruction segments are used to describe the execution process of the computer program 82 in the terminal device 8.

It should be understood that a size of the serial number of each step in the above embodiment does not mean the order of execution. The execution order of each process should be determined by its function and internal logic, and should not constitute any limitation on the implementation process of the embodiment of the present application.

The technical personnel in the related field can clearly understand that, for the convenience and simplicity of description, only the division of the above-mentioned functional units and modules is illustrated, in practical applications, the above-mentioned function distribution can be completed by different functional units and modules as needed, that is, the internal structure of the device is divided into different functional units or modules to complete all or part of the functions described above. Each functional unit and module in the embodiment can be integrated in a processing unit, or each unit can exist physically alone, or two or more units can be integrated in one unit, and the above-mentioned integrated unit can be implemented in the form of hardware or in the form of software functional units. In addition, the specific names of each functional unit and module are also only for the convenience of distinguishing from each other, and are not used to limit the scope of protection of the present application. The specific working process of the unit and module in the above-mentioned system can refer to the corresponding process in the method of the embodiment, and will not be repeated here.

If the integrated unit is implemented in the form of a software functional unit and sold or used as an independent product, it can be stored in a computer-readable storage medium. Based on such understanding, the present application implements all or part of the process in the above-mentioned embodiment method, and can be completed by instructing the relevant hardware by a computer program, and the computer program can be stored in a computer-readable storage medium; when the computer program is executed by the processor, the steps of the above-mentioned various method embodiments can be implemented. In the embodiment, the computer program includes a computer program code, and the computer program code can be in source code form, object code form, executable file or some intermediate form, etc. The computer-readable medium includes: any entity or device, recording medium, computer memory, read-only memory (ROM), random access memory (RAM), electric carrier signal, telecommunication signal and software distribution medium that can carry the computer program code to the device/terminal device. For example, a USB flash drive, a mobile hard disk, a magnetic disk or an optical disk, etc. In some jurisdictions, according to legislation and patent practice, the computer-readable medium cannot be an electric carrier signal and a telecommunication signal.

An embodiment of the present application also provides a computer-readable storage medium, which stores a computer program. When the computer program is executed by a processor, it can implement the steps in the above-mentioned method embodiments.

An embodiment of the present application provides a computer program product. When the computer program product is run on a terminal device such as a POS terminal, the POS terminal can implement the steps in the above-mentioned various method embodiments.

In the above embodiments, the description of each embodiment has its own emphasis. For the parts that are not described or recorded in detail in a certain embodiment, reference can be made to the relevant descriptions of other embodiments.

Those of ordinary skill in the art will appreciate that the units and algorithmic steps of each example described in conjunction with the embodiments disclosed herein can be implemented with a combination of electronic hardware or computer software and electronic hardware. Whether these functions are performed in hardware or software mode depends on the specific application and design constraints of the technical solution. Professional and technical personnel can use different methods to implement the described functions for each specific application, but this implementation should not be considered to exceed the scope of the application.

In the embodiment provided by the application, it should be appreciated that disclosed device/equipment and method can be realized by other modes. For example, the device/equipment embodiment described above is only schematic, for example, the division of described module or unit, is only a kind of logical function division, and other division mode can be arranged during actual realization, for example, multiple units or assemblies can be combined or can be integrated into another system, or some features can be ignored, or do not execute. In another embodiment, the mutual coupling or direct coupling or communication connection shown or discussed can be by some interfaces, the indirect coupling or communication connection of device or unit, can be electrical, mechanical or other form.

The units described as separate components may or may not be physically separated, and the components displayed as units may or may not be physical units, that is, they may be located in one place, or they may be distributed on multiple network units. Some or all of the units may be selected according to actual needs to achieve the purpose of the present embodiment.

The above-described embodiments are only used to illustrate the technical solutions of the present application, rather than to limit them. Although the present application has been described in detail with reference to the aforementioned embodiments, a person of ordinary skill in the art should understand that the technical solutions described in the aforementioned embodiments can still be modified, or some of the technical features thereof can be replaced by equivalents. Such modifications or replacements do not deviate the essence of the corresponding technical solutions from the spirit and scope of the technical solutions of the embodiments of the present application, and should all be included in the protection scope of the present application.

1. A data processing method, comprising:
invoking a library interface of a middle layer library by using an upper layer application; and
implementing a function corresponding to the library interface by invoking a bottom layer application programming interface by the middle layer library.

2. The data processing method according to claim 1, further comprising:
obtaining designated function data; and
encapsulating the designated function data into function modules and generating the library interface.

3. The data processing method according to claim 2, wherein obtaining the designated function data comprises:
obtaining function data; and
classifying the function data and obtaining the designated function data.

4. The data processing method according to claim 2, wherein
encapsulating the designated function data into the function modules and generating the library interface comprises:
defining difference of a plurality of designated function data by macros; and
generating corresponding library interface for the plurality of designated function data defined by the macros.

5. The data processing method according to claim 4, wherein generating corresponding library interface comprises:
compiling and generating the corresponding library interface respectively by using a script tool.

6. The data processing method according to claim 2, after generating the library interface, the method further comprising:
adapting and debugging the library interface, and making the library interface adapt to the device.

7. The data processing method according to claim 2, wherein encapsulating the designated function data into the function modules and generating the library interface comprises:
setting parameter adjustment items for the designated function data, and encapsulating the function modules and generating the library interface.

8. The data processing method according to claim 1, wherein invoking the library interface of the middle layer library by the upper layer application, comprising:
sequentially invoking a plurality of library interfaces of the middle layer library by the upper layer application; or
directly invoking the library interface of the middle layer library by the upper layer application.

9. A terminal device, comprising:
a memory;
a processor, when the at least one instruction is executed by the processor, the processor is caused to:
invoke a library interface of a middle layer library by using an upper layer application; and
implement a function corresponding to the library interface by invoking a bottom layer application programming interface by the middle layer library.

10. A non-transitory storage medium having stored thereon instructions that, when executed by at least one processor of a terminal device, causes the least one processor to execute instructions of a data processing method, the method comprising:
invoking a library interface of a middle layer library by using an upper layer application; and
implementing a function corresponding to the library interface by invoking a bottom layer application programming interface by the middle layer library.

11. The terminal device according to claim 9, wherein the processor further:
obtain designated function data; and
encapsulate the designated function data into function modules and generate the library interface.

12. The terminal device according to claim 11, wherein the processor obtains the designated function data by:
obtaining function data; and
classifying the function data and obtaining the designated function data.

13. The terminal device according to claim 11, wherein the processor encapsulates the designated function data into the function modules and generates the library interface by:
defining difference of a plurality of designated function data by macros; and
generating corresponding library interface for the plurality of designated function data defined by the macros.

14. The terminal device according to claim 13, wherein the processor generates corresponding library interface by:
compiling and generating the corresponding library interface respectively by using a script tool.

15. The terminal device according to claim 11, after generating the library interface, the processor further:
adapts and debugs the library interface, and makes the library interface adapt to the device.

16. The terminal device according to claim 11, wherein the processor encapsulates the designated function data into the function modules and generates the library interface by:
setting parameter adjustment items for the designated function data, and encapsulating the function modules and generating the library interface.

17. The terminal device according to claim 9, wherein the processor invokes the library interface of the middle layer library by the upper layer application by:
sequentially invoking a plurality of library interfaces of the middle layer library by the upper layer application; or
directly invoking the library interface of the middle layer library by the upper layer application.

18. The non-transitory storage medium according to claim 10, the method further comprising:
obtaining designated function data; and
encapsulating the designated function data into function modules and generating the library interface.

19. The non-transitory storage medium according to claim 18, wherein obtaining the designated function data comprises:
obtaining function data; and
classifying the function data and obtaining the designated function data.

20. The non-transitory storage medium according to claim 18, wherein encapsulating the designated function data into the function modules and generating the library interface comprises:
defining difference of a plurality of designated function data by macros; and
generating corresponding library interface for the plurality of designated function data defined by the macros.
